(19) United States
(12) Patent Application Publication
(10) Pub. No.: US 2025/0240335 A1
(43) Pub. Date: Jul. 24, 2025

(54) VIRTUAL MEETING BACKGROUND ENHANCEMENT

(71) Applicant: Google LLC, Mountain View, CA (US)

(72) Inventors: Ryan Fedyk, Brooklyn, NY (US); Anton Volkov, Seattle, WA (US)

(21) Appl. No.: 18/417,626

(22) Filed: Jan. 19, 2024

(51) Int. Cl. H04L 65/1089; G06F 3/04845; G06F 3/14

(52) U.S. Cl. CPC H04L 65/1089; G06F 3/04845; G06F 3/1454

(57) ABSTRACT

A method includes causing presentation of a virtual meeting UI during a virtual meeting. The virtual meeting UI includes one or more regions corresponding to video streams associated with meeting participants. The method includes determining that a background of a first region is to be modified in the virtual meeting UI. The method includes identifying a first frame of the first video stream as a candidate for the background of the first region. The method includes generating, using a first generative AI model and using the first frame as input to the first generative AI model, an enhanced background image. The method includes, for each of one or more second frames of the first video stream, generating a composite image by superimposing an image of the first participant on the enhanced background image and causing the composite image to be presented in the first region of the virtual meeting UI.

### TECHNICAL FIELD

Aspects and implementations of the present disclosure relate to virtual meetings and more specifically to virtual meeting background enhancement.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the virtual meeting platform can provide a user interface that includes multiple regions to display the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a method for virtual meeting background enhancement. The method may include causing a virtual meeting user interface (UI) to be presented during a virtual meeting between one or more participants. The virtual meeting UI may include one or more regions each corresponding to a video stream associated with one or more of the one or more participants. The method may include determining, during the virtual meeting, that a background of a first region corresponding to a first video stream associated with a first participant of the one or more participants is to be modified in the virtual meeting UI. The method may include identifying a first frame of the first video stream as a candidate for the background of the first region. The method may include generating, using a first generative artificial intelligence (AI) model and using the first frame as input to the first generative AI model, an enhanced background image. The method may include, for each of one or more second frames of the first video stream, generating a composite image by superimposing an image of the first participant depicted in a respective second frame of the one or more second frames of the video stream on the enhanced background image, and causing the composite image to be presented in the first region of the virtual meeting UI in place of the respective second frame.

Another aspect of the disclosure provides another method for virtual meeting background enhancement. The method may include causing a virtual meeting user interface (UI) to be presented during a virtual meeting between one or more participants. The virtual meeting UI may include one or more regions each corresponding to a video stream associated with one or more of the participants. The method may include determining, during the virtual meeting, that a background of a first region corresponding to a first video stream associated with a first participant of the one or more participants is to be modified in the virtual meeting UI. The method may include identifying a first frame of the first video stream as a candidate for the background of the first region. The method may include generating, using a first generative artificial intelligence (AI) model and using the first frame as input to the first generative AI model, a text description of the first frame. The method may include generating a generative AI prompt that includes at least a portion of the text description of the first frame. The method may include generating, using a second generative AI model and using the generative AI prompt as input to the second generative AI model, an enhanced background image. The method may include for each of one or more second frames of the video stream, generating a composite image by superimposing an image of the first participant depicted in a respective second frame of the one or more second frames of the video stream on the enhanced background image, and causing the composite image to be presented in the first region of the virtual meeting UI in place of the respective second frame.

Another aspect of the disclosure provides another method for virtual meeting background enhancement. The method may include causing a virtual meeting user interface (UI) to be presented during a virtual meeting between one or more participants. The virtual meeting UI may include one or more regions each corresponding to a video stream associated with one or more of the one or more participants. The method may include determining, during the virtual meeting, that a background of a first region corresponding to a first video stream associated with a first participant of the one or more participants is to be modified in the virtual meeting UI. The method may include generating a generative AI prompt that includes a text description. The method may include generating, using a generative AI model and using the generative AI prompt as input to the generative AI model, an enhanced background image. The method may include, for each of one or more second frames of the video stream, generating a composite image by superimposing an image of the first participant depicted in a respective second frame of the one or more second frames of the video stream on the enhanced background image, and causing the composite image to be presented in the first region of the virtual meeting UI in place of the respective second frame.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for virtual meeting background enhancement, in accordance with some implementations of the present disclosure.

FIG. 2 depicts a flow diagram of a method for performing virtual meeting background enhancement, in accordance with some implementations of the present disclosure.

FIG. 3 illustrates an example user interface for a virtual meeting platform with a virtual meeting background enhancement button, in accordance with some implementations of the present disclosure.

FIG. 4 depicts an example artificial intelligence (AI) subsystem for a virtual meeting platform with a virtual meeting background enhancement button, in accordance with some implementations of the present disclosure.

FIG. 5A depicts an example user interface demonstrating non-use of virtual meeting background enhancement, in accordance with some implementations of the present disclosure.

FIG. 5B depicts an example user interface demonstrating use of virtual meeting background enhancement, in accordance with some implementations of the present disclosure.

FIG. 6 depicts a flow diagram of a method for performing virtual meeting background enhancement, in accordance with some implementations of the present disclosure.

FIG. 7 depicts a flow diagram of a method for performing virtual meeting background enhancement, in accordance with some implementations of the present disclosure.

FIG. 8 is a block diagram illustrating an exemplary computer system, in accordance with some implementations of the present disclosure.

### DETAILED DESCRIPTION

Aspects of the present disclosure relate to enhancing a virtual meeting participant's background for a virtual meeting. A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to one hundred or more client devices) to be connected via the virtual meeting.

A participant of a virtual meeting can speak to the other participants of the virtual meeting. Some existing virtual meeting platforms can provide a user interface (UI) to each client device connected to the virtual meeting, where the UI displays the video streams shared over the network in a set of regions in the UI. In a typical virtual meeting, a video stream shows the respective participant in the participant's real surroundings. However, sometimes, a virtual meeting participant does not want to show their real surroundings during a virtual meeting, for example, because the participant's current surroundings are not tidy, professional, or pleasant to look at for other participants. Some virtual meeting platforms allow a participant to digitally replace their real surroundings in a video stream with a virtual background. However, conventional virtual backgrounds are pre-generated images with little or no affinity with the participant. Furthermore, with the rise of remote work, many employees meet using virtual meetings instead of meeting rooms with corporate branding. This can reduce virtual meetings participants' sense of shared space and corporate team identity.

Furthermore, current virtual meeting platforms are typically unable to align facial features and scale the size of the participants to a common value, contrary to face-to-face meetings, in which participants' facial features and body sizes usually match up. The mismatch present in current virtual meeting platforms generates an unrealistic visual display that causes a participant to jump between rows of differently sized and misaligned faces, resulting in meeting fatigue due to frequent eye movement and increasing cognitive load, thereby devaluing the quality of the user experience.

Implementations of the present disclosure address the above and other deficiencies by using an enhanced version of a virtual meeting participant's surroundings as a virtual background for a virtual meeting. In particular, a virtual meeting application can determine that a background of a virtual meeting participant is to be modified. The virtual meeting application can identify a first frame of the participant's video stream as a candidate for the enhanced virtual background. The application can then use the first frame as input to a generative artificial intelligence (AI) model to generate the enhanced background image. The application can repeatedly generate composite images of an image of the virtual meeting participant in a current video stream frame superimposed on the enhanced background image to create a video stream that shows the participant over the enhanced background image. In some implementations, the participant can provide text (e.g., a natural language command) as input to the generative AI model. For example, the participant may provide text for inclusion in a generative AI prompt (discussed below). The text provided by the participant may help direct the generative AI model in enhancing the background image. In one or more implementations, the AI model can use corporate branding images or other materials to enhance the virtual background or generate a new virtual background.

Aspects of the present disclosure provide technical advantages over previous solutions. Aspects of the present disclosure can provide additional functionality to a virtual meeting platform by providing tools that use generative AI to enhance a virtual meeting participant's surroundings. The additional functionality further includes generating optimal framing of a virtual meeting participant in a UI region displaying a video stream of that participant. The functionality provides an improved user experience during virtual meetings by reducing meeting fatigue and providing more authentic virtual backgrounds for virtual meeting participants.

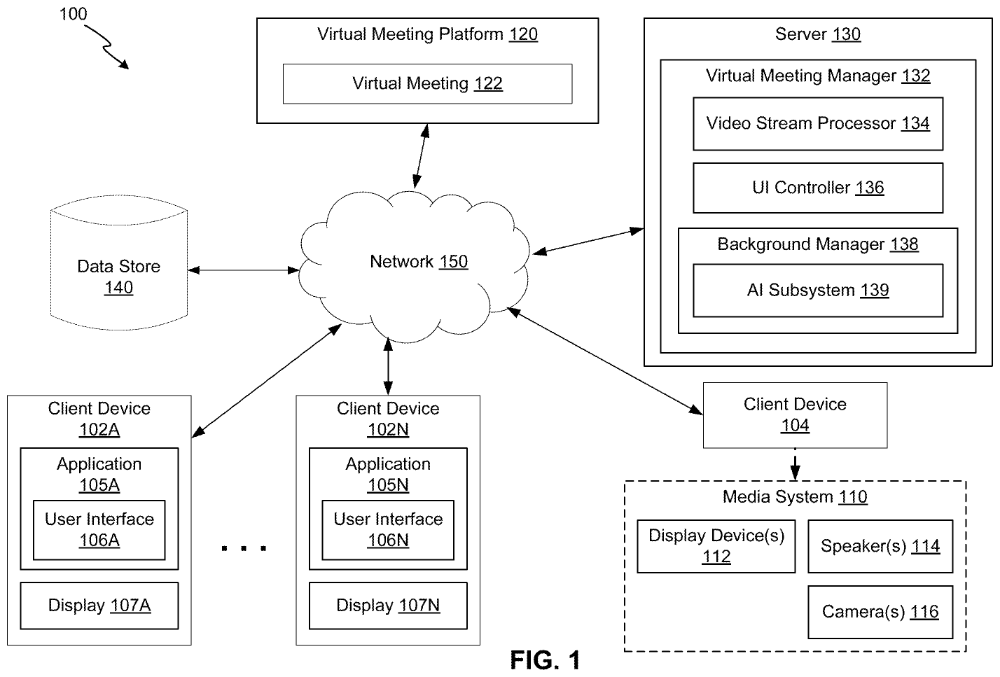

FIG. 1 illustrates an example system architecture 100, in accordance with implementations of the present disclosure. System architecture 100 includes one or more client devices 102A-102N or 104, a virtual meeting platform 120, a server 130, and a data store 140, each connected to a network 150.

In some implementations, the virtual meeting platform 120 can enable users of one or more of the client devices 102A-102N, 104 to connect with each other in a virtual meeting (e.g., a virtual meeting 122). A virtual meeting 122 refers to a real-time communication session such as a video-based call or video chat, in which participants can connect with multiple additional participants in real-time and be provided with audio and video capabilities. A virtual meeting 122 may include an audio-based call or chat, in which participants connect with multiple additional participants in real-time and are provided with audio capabilities. Real-time communication refers to the ability for users to communicate (e.g., exchange information) instantly without transmission delays and/or with negligible (e.g., milliseconds or microseconds) latency. The virtual meeting platform 120 can allow a user of the virtual meeting platform 120 to join and participate in a virtual meeting 122 with other users of the virtual meeting platform 120 (such users sometimes being referred to, herein, as “virtual meeting participants” or, simply, “participants”). Implementations of the present disclosure can be implemented with any number of participants connecting via the virtual meeting 122 (e.g., up to one hundred or more).

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the virtual meeting platform 120 or a virtual meeting manager 132 (discussed below) collects user information (e.g., information about a user's social network, social actions or activities, profession, a user's preferences, or a user's current location), or to control whether or how to receive content from the virtual meeting platform 120 or the virtual meeting manager 132 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 132.

In some implementations, the server 130 may include a virtual meeting manager 132. The virtual meeting manager 132, in one or more implementations, may be configured to manage a virtual meeting 122 between multiple users of the virtual meeting platform 120. In some implementations, the virtual meeting manager 132 may provide the virtual meeting UIs 106A-106N (sometimes referred to as, simply, “the UIs 106A-106N”) to each client device 102A-N, 104 to enable users to watch and listen to each other during a virtual meeting 122. The virtual meeting manager 132 can also collect and provide data associated with the virtual meeting 122 to each participant of the virtual meeting 122. In some implementations, virtual meeting manager 132 can provide the UIs 106A-106N for presentation by client applications 105A-N. For example, the respective UIs 106A-106N can be displayed on the display devices 107A-107N by the client applications 105A-N executing on the operating systems of the client devices 102A-102N, 104. In some implementations, the virtual meeting manager 132 can determine visual items for presentation in the UIs 106A-106N during a virtual meeting 122. A visual item can refer to a UI element that occupies a particular region in the UI 106A-106N and is dedicated to presenting a video stream from a respective client device. Such a video stream can depict, for example, a user of the respective client device 102A-N, 104 while the user is participating in the virtual meeting 122 (e.g., speaking, presenting, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, etc.

In some implementations, the virtual meeting manager 132 may include a video stream processor 134 and a UI controller 136. Each of the video stream processor 134 or the UI controller 136 may include a software application (or a subset thereof) that performs certain virtual meeting functionality for the virtual meeting 122. The video stream processor 134 may be configured to receive video streams from one or more of the client devices 102A-102N, 104. The video stream processor 134 may be configured to determine visual items for presentation in the UI 106A-106N of such client devices 102A-N, 104 during the virtual meeting 122. Each visual item can correspond to a video stream from a client device (e.g., the video stream pertaining to one or more participants of the virtual meeting 122). In some implementations, the video stream processor 134 can receive audio streams associated with the video streams from the client devices (e.g., from an audiovisual component of the client devices 102A-102N). Once the video stream processor 134 has determined visual items for presentation in the UI 106A-106N, the video stream processor 134 can notify the UI controller 136 of the determined visual items. The visual items for presentation can be determined based on current speaker, current presenter, order of the participants joining the virtual meeting 122, list of participants (e.g., alphabetical), configuration settings, etc.

In some implementations, the UI controller 136 can provide the UI 106A-106N for the virtual meeting 122. The UI 106A-106N can include multiple regions. Each region can display a visual item corresponding to a video stream pertaining to one or more participants of the virtual meeting 122. The UI controller 136 can control which video stream's visual item is to be displayed in a specific region of a virtual meeting UI 106A-106N. The UI controller 136 may generate the UIs 106A-106N for the different client devices 102A-102N, 104 and provide the UIs 106A-106N to the client devices 102A-102N, 104. The UI controller 136 may generate different UIs 106A-106N for different client devices 102A-102N, 104. In some implementations, the UI controller 136 may generate partial virtual meeting UIs 106A-106N for the applications 105A-105N, and the applications 105A-105N may finalize the UIs 106A-106N for display on the displays 107A-107N.

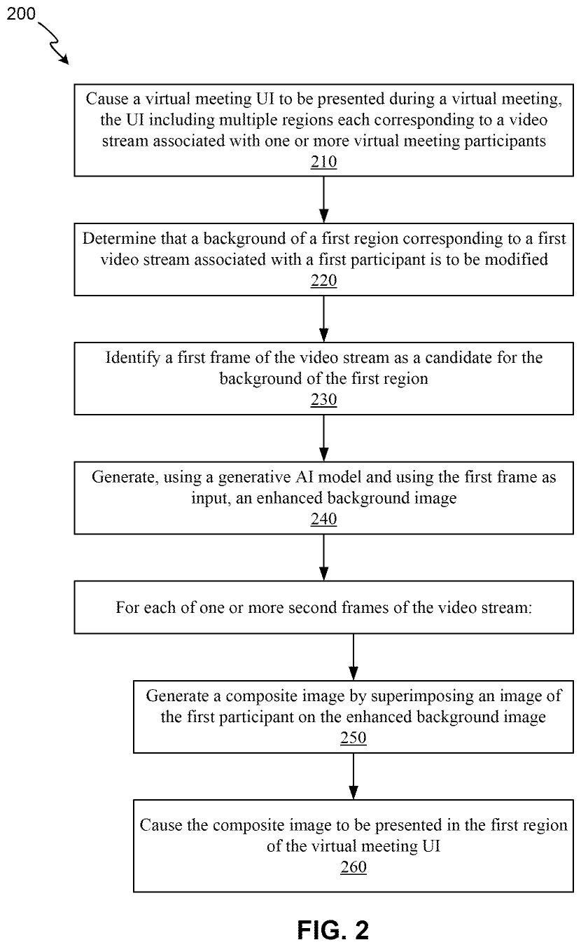

In one or more implementations, the virtual meeting manager 132 may include a background manager 138. The background manager 138 may include a software application (or a subset thereof) that performs certain virtual meeting functionality for a virtual meeting 122. The background manager 138 may be configured to enhance the background of a virtual meeting participant using generative AI. The background manager 138 may include an AI subsystem 139 that may include one or more generative AI models that the background manager 138 may use to enhance a participant's background, as discussed further below. Functionality of the background manager 138 is discussed further below in relation to FIGS. 2, 5, and 6.

As used herein, the term “background” may refer to an area in a virtual meeting participant's visual item that surrounds the image of the participant. The background may include a real physical background, which may include a location and one or more objects near the participant and that are viewable from the participant's video camera. The background may include a virtual background, which may include an image over which an image of the participant is superimposed and replaces the participant's real physical background during the virtual meeting.

In some implementations, the virtual meeting platform 120 or the server 130 can include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 122. The virtual meeting platform 120 can also include a website (e.g., one or more webpages) or application back-end software that can be used to enable a user to connect with other users by way of the virtual meeting 122.

In some implementations, the one or more client devices 102A-102N can each include one or more computing devices such as personal computers (PCs), laptops, mobile phones, smart phones, tablet computers, netbook computers, network-connected televisions, etc. In some implementations, the one or more client devices 102A-102N can also be referred to as “user devices.” Each client device 102A-102N can include an audiovisual component that can generate audio and video data to be streamed to the virtual meeting platform 120. In one or more implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-102N. In some implementations, the audiovisual component can also include an image capture device (e.g., a camera) to capture images and generate video data (e.g., a video stream) of the captured data of the captured images.

In some implementations, the system architecture 100 may include a client device 104. The client device 104 may differ from a client device of the one or more client devices 102A-N because the client device 104 may be associated with a physical conference or meeting room. Such client device 104 can include or be coupled to a media system 110 that can include one or more display devices 112, one or more speakers 114 and one or more cameras 116. Display device 112 can be, for example, a smart display or a non-smart display (e.g., a display that is not itself configured to connect to the network 150). Users that are physically present in the room can use the media system 110 rather than their own devices (e.g., one or more of the client devices 102A-102N) to participate in the virtual meeting 122, which can include other remote users. For example, the users in the room that participate in the virtual meeting 122 can control the display device 112 to show a slide presentation or watch slide presentations of other participants. Sound and/or camera control can similarly be performed. Similar to client devices 102A-102N, the one or more client devices 104 can generate audio and video data to be streamed to the virtual meeting platform 120 (e.g., using one or more microphones, speakers 114 and cameras 116).

As described previously, an audiovisual component of each client device 102A-N, 104 can capture images and generate video data (e.g., a video stream) of the captured data of the captured images. In some implementations, the client devices 102A-102N, 104 can transmit the generated video stream to virtual meeting manager 132. The audiovisual component of each client device 102A-N, 104 can also capture an audio signal representing speech of a user and generate audio data (e.g., an audio file or audio stream) based on the captured audio signal. In some implementations, the client devices 102A-102N, 104 can transmit the generated audio data to the virtual meeting manager 132.

In some implementations, each client device 102A-102N or 104 can include client application 105A-N, which can be a mobile application, a desktop application, a web browser, etc. In some implementations, the client application 105A-N can present, on a display device 107-107N of a client device 102A-102N or a UI (e.g., a UI of the UIs 106A-106N), one or more features of the application 105A-N for users to access the virtual meeting platform 120. For example, a user of client device 102A can join and participate in the virtual meeting 122 via a UI 106A presented on the display device 107A by the application 105A. The user may present a document to participants of the virtual meeting 122 using the UI 106A. Each of the UIs 106A-106N can include multiple regions to present visual items corresponding to video streams of the client devices 102A-102N provided to the server 130 for the virtual meeting 122. In some implementations, the application 105A-N may provide auto-framing functionality, as discussed further below.

In one or more implementations, the background manager 138 may be part of a client device 102A-102N, 104. For example, the application 105A-105N may include the background manager 138. In one implementation, the application 105A of the client device 102A may generate a video stream. The video stream may include composite images created by superimposing sequential images of the participant that is using the client device 102A on an enhanced background image generated by the background manager 138, as discussed herein. The application 105A may send the video stream to the virtual meeting manager 132, which may use the UI controller 136 to generate the virtual meeting UIs and provide the UIs to the client devices 102A-102N, 104. In some implementations, the application 105A may send the video stream to the other client devices 102B-N, 104, and receive the video stream from the other client devices 102B-N, 104, and the applications 105A-105N may generate their respective virtual meeting UIs 106A-106N or may finalize their respective UIs 106A-106N, which may have been partially generated by the UI controller 136.

In some implementations, the data store 140 is a persistent storage that is capable of storing data as well as data structures to tag, organize, and index the data. A data item can include audio data and/or video stream data, in accordance with implementations described herein. The data store 140 can be hosted by one or more storage devices, such as main memory, magnetic or optical storage-based disks, tapes, hard drives, flash memory, and so forth. In some implementations, the data store 140 can be a network-attached file server, while in other implementations, the data store 140 can be some other type of persistent storage such as an object-oriented database, a relational database, and so forth, that can be hosted by the virtual meeting platform 120 or one or more different machines (e.g., the server 130) coupled to the virtual meeting platform 120 using the network 150. In some implementations, the data store 140 can store portions of audio and video streams received from one or more client devices 102A-102N for the virtual meeting platform 120. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-102N and/or concurrently editable by the users.

In some implementations, the network 150 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

It should be noted that in some other implementations, the functions of the virtual meeting platform 120 or the server 130 can be provided by a fewer number of machines. For example, in some implementations, the server 130 can be integrated into a single machine, while in other implementations, the server 130 can be integrated into multiple machines. In addition, in some implementations, the server 130 can be integrated into the virtual meeting platform 120.

In general, one or more functions described in the several implementations as being performed by the virtual meeting platform 120 or server 130 can also be performed by the client devices 102A-N, 104 in other implementations, if appropriate. In addition, in some implementations, the functionality attributed to a particular component can be performed by different or multiple components operating together. The virtual meeting platform 120 or the server 130 can also be accessed as a service provided to other systems or devices through appropriate application programming interfaces, and thus is not limited to use in websites.

Although implementations of the disclosure are discussed in terms of the virtual meeting platform 120 and users of the virtual meeting platform 120 participating in a virtual meeting 122, implementations can also be generally applied to any type of telephone call, conference call, or other technological communications methods between users. Implementations of the disclosure are not limited to virtual meeting platforms that provide virtual meeting tools to users.

FIG. 2 is a flowchart illustrating one embodiment of a method 200 for performing background enhancement for a virtual meeting 122, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 200 and/or one or more of the method's 200 individual functions, routines, subroutines, or operations. In certain implementations, a single processing thread can perform the method 200. Alternatively, two or more processing threads can perform the method 200, each thread executing one or more individual functions, routines, subroutines, or operations of the method. In an illustrative example, the processing threads implementing the method 200 can be synchronized (e.g., using semaphores, critical sections, and/or other thread synchronization mechanisms). Alternatively, the processing threads implementing the method 200 can be executed asynchronously with respect to each other. Various operations of the method 200 can be performed in a different (e.g., reversed) order compared with the order shown in FIG. 2. Some operations of the method 200 can be performed concurrently with other operations. Some operations can be optional. In some implementations, the virtual meeting manager 132 or the background manager 138 may perform one or more of the operations of the method 200.

At block 210, processing logic may cause a virtual meeting UI 106A-N to be presented during a virtual meeting 122 between one or more participants. The virtual meeting UI 106A-N can be provided by the virtual meeting manager 132 or the UI controller 136, which may reside on the server 130. In some implementations, a client device 102A-102N, 104 may provide the virtual meeting UI 106A-N. The virtual meeting UI 106A-N may include one or more regions each corresponding to a video stream associated with one or more of the participants.

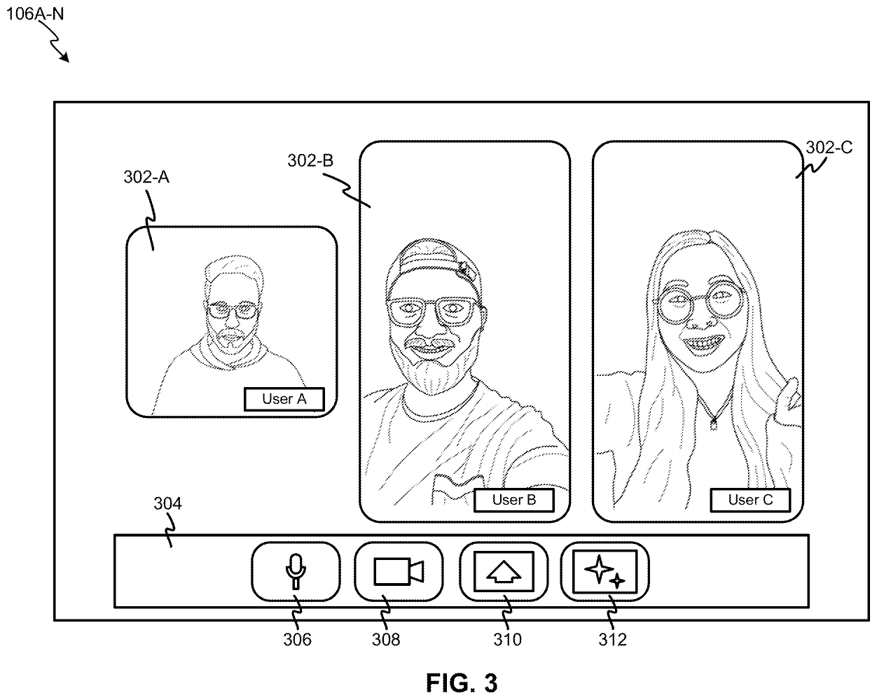

FIG. 3 depicts one example implementation of a virtual meeting UI 106A-N. A UI 106A-N may include the virtual meeting UI 106A-N. The virtual meeting UI 106A-N may include one or more regions 302A-C. Each region 302A-C may correspond to a video stream associated with one or more participants using the client devices 102A-N. For example, the region 302A may correspond to a participant using the client device 102A, the region 302B may correspond to a participant using the client device 102B, and the region 302C may correspond to a participant using the client device 102C. As can be seen in FIG. 3, each region 302A-C may display the video stream associated with their respective participant. As can also be seen in FIG. 3, different regions 302A-C may be of different sizes. The order or placement of the regions 302A-C may depend on an order in which the respective participants joined the virtual meeting 122, a dimension of the video stream, or some other configuration.

In some implementations, the virtual meeting UI 106A-N may include a tool panel 304. The tool panel 304 may include one or more UI elements (e.g., buttons, icons, menus, windows, etc.) to select desired audio features, video features, etc. For example, the tool panel 304 may include an audio button 306 that may mute or unmute the participant, a video button 308 that may cause the video stream to start or stop being broadcast to other participants, or a share button 310 that may allow a participant to share the screen of their client device 102A-N. The tool panel 304 may include a background enhancement UI element 312, which may activate or deactivate background enhancement functionality, as discussed herein.

Returning to FIG. 2, at block 220, processing logic may determine, during the virtual meeting 122, that the background of a first region 302A corresponding to a first video stream is to be modified in the virtual meeting UI 106A-N. The first video stream may be associated with a first participant of the one or more participants (e.g., here, the participant using the client device 102A). Determining that the background of the first region 302A is to be modified may be in response to the first participant interacting with the background enhancement UI element 312 on the participant's UI 106A-N. Determining that the background of the first region 302A is to be modified may be in response to the background manager 138 determining a characteristic of the first video stream. For example, the background manager 138 may obtain a frame from the video stream associated with the first region 302 and input the frame into an image recognition AI model of the AI subsystem 139. The image recognition AI model may determine, from the input frame, whether the participant's surroundings (as contained in the frame) are cluttered, poorly lit, aesthetically unpleasing, or some other characteristic. In some implementations, the processing logic may modify the background of the first region 302A by default, and the first participant may deactivate the background enhancement feature by interacting with the background enhancement UI element 312.

At block 230, processing logic may identify a first frame of the first video stream as a candidate for the background of the first region 302A. The first frame may include a frame from the video stream associated with the first region 302A. The first frame may include a video frame obtained from a camera that is in data communication with the client device 102A (e.g., a camera integrated with the client device 102A or a universal serial bus (USB) camera plugged into a port of the client device 102A). The first frame may include an image of the participant using the client device 102A and may include an image of the participant's surroundings.

In some implementations, the first frame may include an image of the first participant in an area of the first frame. The application 105A may remove the image of the participant from the area, or the application 105A may send the first frame to the background manager 138, and the background manager 138 may remove the image of the participant. As a result, the first frame may include an image of the background with a blank space in the area where the image of the participant used to be located. In one implementation, the background manager 138 may cause a first AI model of the AI subsystem 139 to fill the blank space area.

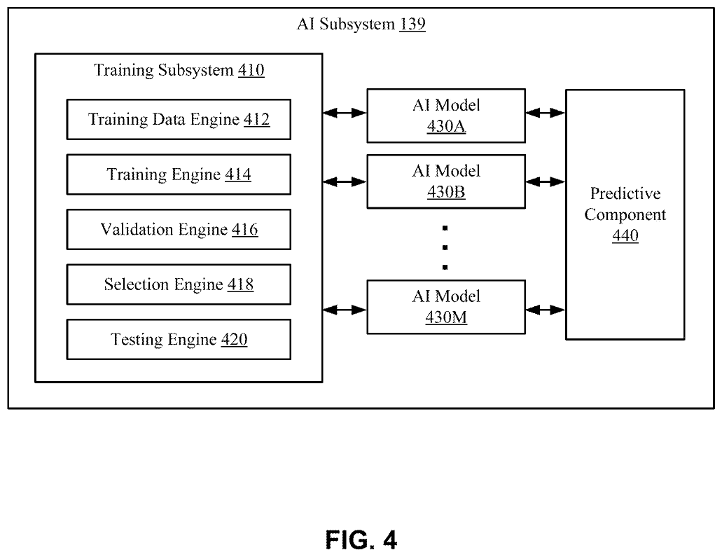

FIG. 4 illustrates an example AI subsystem 139, in accordance with implementations of the present disclosure. As illustrated in FIG. 4, the AI subsystem 139 can include a training subsystem 410, which may include a training data engine 412, a training engine 414, a validation engine 416, a selection engine 418, or a testing engine 420. The AI subsystem 139 may include one or more AI models 430A-M. The AI subsystem 139 may include a predictive component 440.

In one embodiment, an AI model 430A-M may include one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron may be connected to one or more neurons via one or more edges (“synapses”). The synapses may perpetuate a signal from one neuron to another, and a weight, bias, or other configuration of a neuron or synapse may adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that may be used is a long short term memory (LSTM) neural network.

ANNs may learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one embodiment, an AI model 430A-M may include a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), a large language model (LLM), or a diffusion model. In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some embodiments, an AI model 430A-M can be an AI model 430A-M that has been trained on a corpus of data. In some embodiments, the AI model 430A-M can be a model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 430A-M to learn broad elements including, image or speech recognition, general sentence structure, common phrases, vocabulary, natural language structure, and other elements. In some embodiments, this first, foundational model can be trained using self-supervision, or unsupervised training on such datasets.

In some embodiments, the second portion of training, including fine-tuning, may be unsupervised, supervised, reinforced, or any other type of training. In some embodiments, this second portion of training may include some elements of supervision, including learning techniques incorporating human or machine-generated feedback, undergoing training according to a set of guidelines, or training on a previously labeled set of data, etc. In a non-limiting example associated with reinforcement learning, the outputs of the AI model 430A-M while training may be ranked by a user, according to a variety of factors, including accuracy, helpfulness, veracity, acceptability, or any other metric useful in the fine-tuning portion of training. In this manner, the AI model 430A-M can learn to favor these and any other factors relevant to users when generating a response. Further details regarding training are provided below.

In some embodiments, an AI model 430A-M may include one or more pre-trained models, or fine-tuned models. In a non-limiting example, in some embodiments, the goal of the “fine-tuning” may be accomplished with a second, or third, or any number of additional models. For example, the outputs of the pre-trained model may be input into a second AI model 430B that has been trained in a similar manner as the “fine-tuned” portion of training above. In such a way, two more AI models 430A-M may accomplish work similar to one model that has been pre-trained, and then fine-tuned.

As indicated above, an AI model 430A-M may be one or more generative AI models, allowing for the generation of new and original content. In one implementation, the generative AI model may include a diffusion model. A diffusion model may include a deep generative model that can be used to generate images, edit existing images, and create new image styles. The diffusion model may have been trained by iteratively applying a diffusion process to an input image, which may include gradually adding noise to the image until it becomes unrecognizable. The diffusion model then learns to reverse this process, starting from the noisy image and gradually denoising it until it becomes a recognizable image. In some implementations, the diffusion model may have been trained on multiple virtual meeting backgrounds by using different virtual meeting backgrounds as input images during the training process.

In one implementation, the training subsystem 410 may manage the training and testing of the one or more AI models 430A-M. The training data engine 412 may generate training data (e.g., a set of training inputs and a set of target outputs) to train the one or more AI model 430A-M. In an illustrative example, the training data engine 412 can initialize a training set T to null (e.g., { }). The training data engine 412 may add the training data to the training set T and may determine whether training set T is sufficient for training an AI model 430A-M. The training set T can be sufficient for training the AI model 430A-M if the training set T includes a threshold amount of training data, in some embodiments. In response to determining that the training set T is not sufficient for training, the training data engine 412 can identify additional data for use as training data. In response to determining that the training set T is sufficient for training, the training data engine 412 may provide the training set T to the training engine 414.

The training engine 414 can train an AI model 430A-M using the training data (e.g., training set T). The AI model 430A-M may refer to the model artifact that is created by the training engine 414 using the training data, where such training data can include training inputs and, in some implementations, corresponding target outputs (e.g., correct answers for respective training inputs). The training engine 414 can input the training data into the AI model 430A-M so that the AI model 430A-M may find patterns in the training data and configure itself based on those patterns.

Where an AI model 430A-M uses supervised learning, the training engine 414 may assist the AI model 430A-M in determining whether the AI model 430A-M maps the training input to the target output (the answer to be predicted). Where the AI model 430A-M uses unsupervised learning, the training engine 414 may input the training data into the AI model 430A-M. The AI model 430A-M may configure itself based on the input training data, but since the training data may not include a target output, the training engine 414 may not assist the AI model 430A-M in determining whether the AI model 430A-M provided a correct output during the training process.

The validation engine 416 may be capable of validating a trained AI model 430A-M using a corresponding set of features of a validation set from the training data engine 412. The validation engine 416 may determine an accuracy of one or more of the trained AI models 430A-M based on the corresponding sets of features of the validation set. Where the training data may not include a target output, validating a trained AI model 430A-M may include obtaining an output from the AI model 430A-M and providing the output to another entity for evaluation. The other entity may include another AI model configured to evaluation the output of the AI model 430A-M that is undergoing training. The other entity may include a human. The validation engine 416 may discard a trained AI model 430A-M that has an accuracy that does not meet a threshold accuracy or that otherwise fails evaluation. In some embodiments, the selection engine 418 may be capable of selecting a trained AI model 430A-M that has an accuracy that meets a threshold accuracy. In some embodiments, the selection engine 418 may be capable of selecting the trained AI model that has the highest accuracy of multiple trained AI models 430A-M. In some implementations, the selection engine 418 may receive input from another AI model or a human and may select a trained AI model based on the input.

The testing engine 420 may be capable of testing a trained AI model 430A-M using a corresponding set of features of a testing set from the training data engine 412. For example, a first trained AI model 430A that was trained using a first set of features of the training set may be tested using the first set of features of the testing set. The testing engine 420 may determine a trained AI model 430A-M that has the highest accuracy or other evaluation of all of the trained AI models 430A-M based on the testing sets. The predictive component 440 of the AI subsystem 139 may be configured to feed data as input to an AI model 430A-M and obtain one or more outputs. In some embodiments, the AI subsystem 139 may not be part the background manager 138 and may, instead, be part of another system or sub-system or be an independent system. In some implementations, the AI subsystem 139 may only include the training subsystem 410 that can train the one or more AI models 430A-M and provide them to the background manager 138, which may include the trained AI models 430A-M and the predictive component 440.

Returning to FIG. 2, at block 230, the first AI model 430A may include a diffusion model that may have been trained by the training engine 414. The training data engine 412 may generate training data that includes images of virtual meeting backgrounds, and the training engine 414 may cause the first AI model 430A to undergo a diffusion model training process using the training data. The first AI model 430A may undergo a validation and testing process using the validation engine 416 and testing engine 420. In one implementation, the predictive component 440 may receive the first frame with the image of the background and the blank area from the background manager 138 and provide the first frame as input to the first AI model 430A. The first AI model 430A may, as configured by its training process, perform a diffusion denoising process to fill the blank area with image data such that the area is not blank and blends into the original portion of the image of the background. The first AI model 430A may output the filled-in first frame to the predictive component 440, which may provide the filled-in first frame to the background manager 138.

In some implementations, block 230 may occur at a virtual meeting preparation phase of the virtual meeting 122. The preparation phase may include a presentation of a UI of the application 105A that allows the participant to prepare for entering the virtual meeting 122. While in the preparation phase, the video stream processor 134 may not stream video or audio from the first participant's client device 102A to one or more other client devices 102B-N, 104. The preparation phase may allow the participant to adjust audio or microphone levels, get positioned in front of the camera of the client device 102A, or perform other virtual meeting 122 preparation tasks. The preparation phase may allow the background manager 138 to identify a first frame of the video stream of the client device 102A as a candidate for the background of the first region 302A. The preparation phase may allow the background manager 138 to modify the first frame to remove the image of the participant and fill in the image of the background, as discussed above.

At block 240, processing logic may generate, using a second AI model 430B, an enhanced background image. The second AI model 430B may use the first frame of block 230 as input. In some implementations, the second AI model 430B may include a generative AI model. The second AI model 430B may include a diffusion model. The second AI model 430B may have been trained by the training engine 414. The training data engine 412 may generate training data that includes images of virtual meeting backgrounds, and the training process of the training engine 414 may include the second AI model 430B applying a diffusion denoising process to the images. The second AI model 430B may undergo a validation and testing process using the validation engine 416 and testing engine 420.

Generating the enhanced background image may include the predictive component 440 receiving the first frame from the background manager 138 and providing the first frame to the second AI model 430B. The second AI model 430B may apply a diffusion denoising process to the input first frame to generate an output image. The output image may be similar to the input first frame, but since the second AI model 430B applied the diffusion denoising process, the output image may be slightly improved over the input image. The second AI model 430B may use the output image as input and may apply another diffusion denoising process and output a second output image. The second AI model 430B may iteratively repeat this process until a stop condition is detected (e.g., a predetermined number of iterations have executed, the differences between the input and output images are below a threshold difference, etc.). The second AI model 430B may provide the enhanced background image as output to the predictive component 440, which may provide the enhanced background image to the background manager 138.

In some implementations, generating the enhanced background image may include a third AI model 430C removing portions of the first frame so that the second AI model 430B can fill in those portions. The third AI model 430C may include an image recognition AI model. The third AI model 430C may be configured to recognize certain predetermined objects that should be removed from an image. The predetermined objects may include clutter or other objects that a participant may desire to be removed from their virtual meeting background. The second AI model 430B may then fill in those removed portions using a diffusion process or other generative AI process.

In some implementations, generating the enhanced background image may include using a generative AI prompt as further input to the second AI model 430B. The generative AI prompt may include a command for the second AI model 430B to generate the enhanced background image with one or more image elements. In one or more implementations, generating the enhanced background image may include obtaining the one or more image elements from the virtual meeting UI 106A-N.

In one implementation, the second AI model 430B can be supported by a prompt subsystem (not shown), which may be part of the virtual meeting manager 132. The prompt subsystem may enable a component of the virtual meeting manager 132 to access the second AI model 430B. The prompt subsystem may be configured to perform automated identification of, and facilitate retrieval of, relevant and timely contextual information for efficient and accurate processing of prompts by the second AI model 430B. Using the data network 150 (or another network), the prompt subsystem may be in communication with one or more of the applications 105A-N. Communications between the prompt subsystem and the AI subsystem 139 may be facilitated by a generative model application programming interface (API), in some embodiments. Communications between the prompt subsystem and the one or more applications 105A-N may be facilitated by a data management API. In additional or alternative embodiments, the generative model API can translate prompts generated by the prompt subsystem into unstructured natural-language format and, conversely, translate responses received from the second AI model 430B into any suitable form (e.g., including any structured proprietary format as may be used by the prompt subsystem).

As indicated above, a user can interact with the prompt subsystem via a prompt interface. The prompt interface may include a UI element that can support any suitable types of user inputs (e.g., textual inputs, speech inputs, image inputs, etc.). The UI element may further support any suitable types of outputs (e.g., textual outputs, speech outputs, image outputs, etc.). In some embodiments, the UI 106A-N may include the UI element of the prompt subsystem. The UI element can include selectable items, in some embodiments, that enables a user to select from multiple possible inputs. The UI element can allow the user to provide consent for the prompt subsystem or the generative AI model to access user data or other data associated with a client device 102A-N or stored in the data store 140, process, or store new data received from the user, and the like. The UI element can additionally or alternatively allow the user to withhold consent to provide access to user data. In some embodiments, user input entered using the UI element may be communicated to the prompt subsystem by a user API.

In some embodiments, the prompt subsystem can include a prompt analyzer to support various operations of this disclosure. For example, the prompt analyzer may receive an input (e.g., a prompt submitted by a user of a client device 102A-N) and generate one or more intermediate prompts to the generative AI model to determine what type of data the generative AI model may need to successfully respond to the input. Upon receiving a response from the generative AI model, the prompt analyzer may analyze the response, form a request for relevant contextual data for the data store 140 or other component of the system 100, which may then supply such data. The prompt analyzer may then generate a prompt to the generative AI model that includes the original prompt and the contextual data. In some embodiments, the prompt analyzer may, itself, include a lightweight generative AI model that may process the intermediate prompt(s) and determine what type of contextual data may be needed by the generative AI model together with the original prompt to ensure a meaningful response from generative AI model.

In one implementation, responsive to the first participant interacting with the background enhancement UI element 312, the UI 106A-N may display one or more selectable options that the participant can select in order to include one or more image elements in a generative AI prompt. An image element may include data that the second AI model 430B may use as input to generate the enhanced background image. For example, the selectable options may include options for large art, potted plants, enhanced lighting, windows, furniture, or other objects for the second AI model 430B to include in the enhanced background image. The selectable options may include checkboxes that may allow the participant to select whether to include the selectable option in a generative AI prompt. In some implementations, the UI 106A-N may display a text box where the participant can input text to form an image element. After the participant has provided user input to select one or more selectable options or input text into a text box, the participant may interact with a “Submit” button or some other UI element to indicate that the participant has finished making their selection of image elements. In response, the UI 106A-N may send the selected/inputted image elements to the prompt subsystem to be included in the generative AI prompt to be used as input to the second AI model 430B.

In some implementations, the second AI model 430B may use the first frame and the generative AI prompt as input to generate the enhanced background. As discussed above, the second AI model 430B may include a diffusion model. The second AI model 430B may iteratively perform a diffusion denoising process on the first frame and subsequent output images to generate the enhanced background image. The generative AI prompt, with its one or more image elements, may be used as input to the second AI model 430B to guide the second AI model 430B when performing the diffusion denoising processes.

In some implementations, for each of one or more second frames of the first video stream, at block 250, processing logic may generate a composite image by superimposing an image of the first participant depicted in a respective second frame of the one or more second frames of the video stream on the enhanced background image. In one implementation, the background manager 138 may obtain the image of the participant in the respective second frame. The background manager 138 may obtain the second frame and use a delineation operation to separate the image of the participant from the image of the background of the second frame. The background manager 138 may superimpose the image of the participant on the enhanced background image generated in block 240.

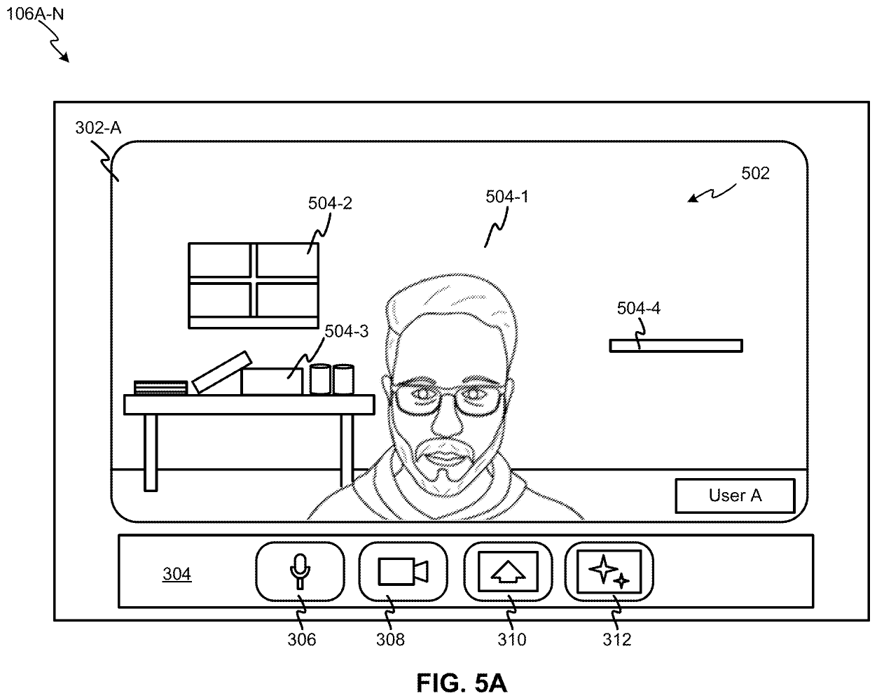

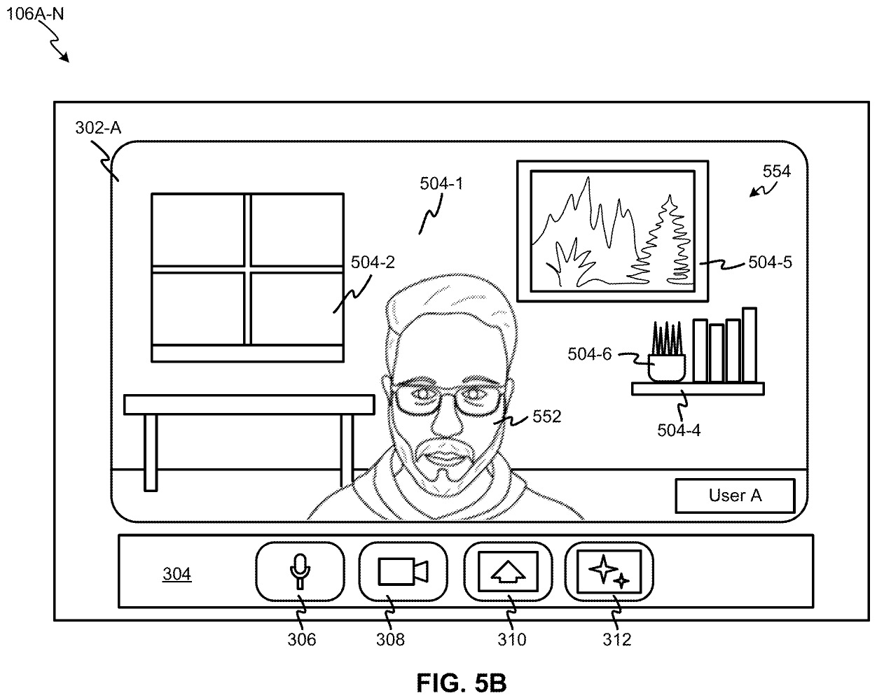

FIG. 5A depicts an example UI 106A-N showing a second frame without the composite image, and FIG. 5B depicts the example UI 106A-N showing the second frame with the composite image. As seen in FIG. 5A, the UI 106A-N includes the first region 302A. The first region 302A includes the video stream associated with the first participant. As is seen in FIG. 5A, the depicted frame of the video stream shows the background 502 of the first participant. The background 502 may include various objects 504, including a wall 504-1, a window 504-2, clutter 504-3, and a shelf 504-4. The first participant may interact with the background enhancement UI element 312 to activate the background enhancement feature of the virtual meeting platform 120, and the background manager 138 may perform one or more operations of the method 200.

As seen in FIG. 5B, responsive to the background enhancement feature being activated, the first region 302A may show the second frame with the composite image. The composite image may include an image 552 of the first participant superimposed over the enhanced background image 554. The background manager 138 may have enhanced the background 502 using one or more generative AI models 430A-M of the AI subsystem 139. For example, the enhanced background image 554 may still include the wall 504-1 and the window 504-2. However, the background manager 138 may have enlarged the window 504-2. The background manager 138 may have removed the clutter 504-3. The background manager 138 may have added artwork 504-5 to the wall 504-1. The background manager 138 may have added a potted plant and books 504-5 to the shelf 504-4.

In one or more implementations, the background manager 138 may superimpose the image 552 of the participant on the enhanced background image 554 using a location and a size of the image 552 of the participant with respect to the respective second frame. The location and size of the image 552 of the participant may include a location and size determined by an auto-framing operation. The location may include a location substantially in the center of the second frame, and the size may include a size such that the edges of the image 552 of the participant's head are a predetermined distance from some of the edges of the second frame. In this manner, the image 552 of the participant may remain substantially centered and at a consistent size from frame to frame (e.g., as a result of using the auto-framing operations).

In some implementations, block 250 may include the background manager 138 performing a facial recognition operation on the image 552 of the participant. The facial recognition operation may identify a head outline of the image 552 of the participant. The head outline may include data indicating where, in the image 552 of the participant, the edges of the participant's head are located. The facial recognition operation may identify a location of facial features in the image 552 of the participant. The background manager 138 may use the identified head outline facial feature locations to help superimpose the image 552 of the participant in the correct location over the enhanced background image 554 and at the correct size.

In one implementation, superimposing the image 552 of the participant on the enhanced background image 554 may include superimposing the image 552 of the participant in a center portion of the enhanced background image 554 based on one or more facial features. Superimposing the image 552 of the participant in a location based on the one or more facial features may help keep the image 552 of the participant substantially centered in the participant's video stream even if the participant moves around relative to the client device's 102A camera (e.g., the participant moving left or right or moving up or down). Keeping the participant substantially centered may result in a better viewing experience for other virtual meeting 122 participants. As an example, the background manager 138 may place the image 552 of the participant over the enhanced background image 554 such that the certain facial features are substantially equidistant from the left and right sides of the enhanced background image 554. In one implementation, superimposing the image 552 of the participant on the enhanced background image may include superimposing the image 552 of the participant such that certain facial features of the participants whose video streams are located in a same row on a virtual meeting UI 106A-N are on the same horizontal level.

In some implementations, superimposing the image 552 of the participant on the enhanced background image 554 may include superimposing a head of the image 552 of the participant a predetermined distance from an edge of the enhanced background image 554 based on the head outline. Superimposing the image 552 of the participant at a predetermined distance from the edge of the enhanced background image 554 may help keep the image 552 of the participant at a substantially consistent size even if the participant moves closer to or further away from the camera. Keeping the participant's head a substantially consistent size may result in a better viewing experience for other virtual meeting 122 participants. As an example, the background manager 138 may superimpose the image 552 of the participant such that a distance from the top edge of the head outline of the participant to the top edge of the enhanced background image 554 substantially equals a first predetermined distance, a distance from the bottom edge of the head outline to the bottom edge of the enhanced background image 554 substantially equals a second predetermined distance, a distance from the left edge of the head outline to the left edge of the enhanced background image 554 substantially equals a third predetermined distance, or a distance from the right edge of the head outline to the right edge of the enhanced background image 554 substantially equals a fourth predetermined distance. In some implementations, the first and second distances may be substantially equal or the third and fourth distances may be substantially equal.

In some implementations, generating the composite image may occur during a live phase of the virtual meeting. A live phase may refer to a phase in which virtual meeting participants are able to interact with each other (e.g., view or hear each other in real-time (or near real-time due to transmission delays, etc.) during the virtual meeting 122).

Returning to FIG. 2, for each of one or more second frames of the first video stream, at block 260, processing logic may cause the composite image to be presented in the first region of the virtual meeting UI 106A-N in place of the respective second frame. In one implementation, the UI controller 136 may obtain the composite image from the background manager 138 and send the composite image, as part of a video stream, to the other client devices 102B-N, 104 to be displayed in the region 302A pertaining to the first participant. As a result, the other participants may view the video stream of the first participant, and the video stream may include the one or more second frames where the background enhancement feature is activated. Thus, the other participants may view the video stream of the first participant of the client device 102A, which may include the enhanced background image 554, which results in a more pleasant virtual meeting 122 experience for the other participants.

In one implementation, the UI 106A-N of the client device 102A of the first participant may also display the video stream containing the one or more second frames (e.g., the first participant can see the first participant's own video stream with the enhanced background image 554). This may allow the first participant to view their own video stream and determine whether the enhanced background feature is working correctly, whether the enhanced background is acceptable to the first participant, etc.

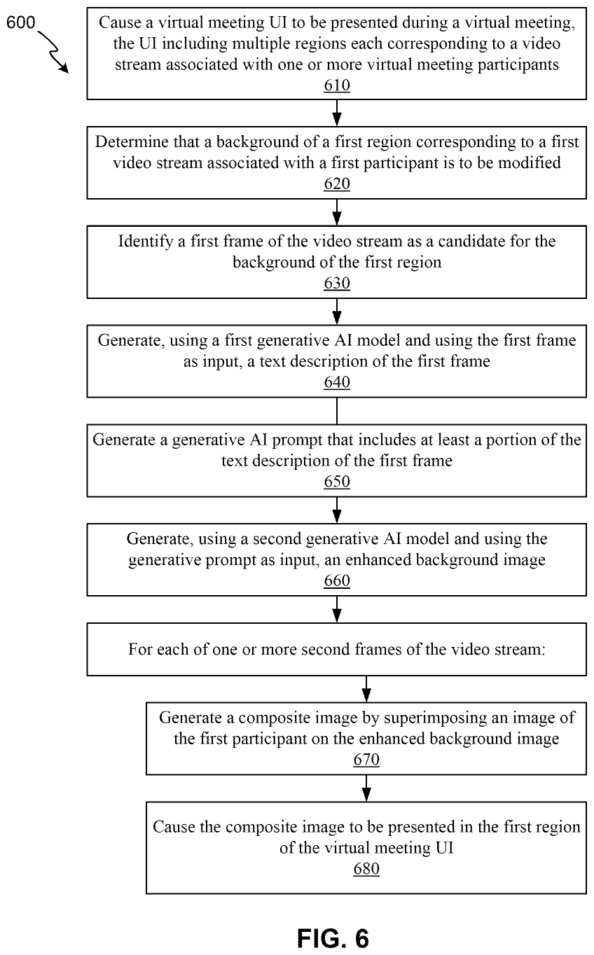

FIG. 6 is a flowchart illustrating one embodiment of a method 600 for performing background enhancement during a virtual meeting, in accordance with some implementations of the present disclosure. A processing device, having one or more (CPU(s), one or more GPU(s), and/or memory devices communicatively coupled to the one or more CPU(s) and/or GPU(s) can perform the method 600 and/or one or more of the method's 600 individual functions, routines, subroutines, or operations. In certain implementations, a single processing thread can perform the method 600. Alternatively, two or more processing threads can perform the method 600, each thread executing one or more individual functions, routines, subroutines, or operations of the method. In an illustrative example, the processing threads implementing the method 600 can be synchronized (e.g., using semaphores, critical sections, and/or other thread synchronization mechanisms). Alternatively, the processing threads implementing the method 600 can be executed asynchronously with respect to each other. Various operations of the method 600 can be performed in a different (e.g., reversed) order compared with the order shown in FIG. 6. Some operations of the method 600 can be performed concurrently with other operations. Some operations can be optional. In some implementations, the virtual meeting manager 132 or the background manager 138 may perform one or more of the operations of the method 600.

At block 610, processing logic may cause a virtual meeting UI 106A-N to be presented during a virtual meeting 122 between one or more participants. The virtual meeting UI 106A-N may include one or more regions 302 each corresponding to a video stream associated with one or more of the participants. Block 610 may include functionality similar to the functionality of block 210 of the method 200.

At block 620, processing logic may determine, during the virtual meeting 122, that the background of a first region 302A corresponding to a first video stream is to be modified in the virtual meeting UI 106A-N. The first video stream may be associated with a first participant of the one or more participants (e.g., here, the participant using the client device 102A). Block 620 may include functionality similar to the functionality of block 220 of the method 200.

At block 630, processing logic may identify a first frame of the first video stream as a candidate for the background of the first region 302A. Block 630 may include functionality similar to the functionality of block 230 of the method 200. In some implementations, processing logic of block 630 may further include removing an image of the first participant from the first frame, as discussed above.

At block 640, processing logic may generate a text description of the first frame. A first generative AI model may generate the text description. The first generative AI model may use the first frame as input. In one implementation, the first generative AI model may include an image captioning model or an image-to-text retrieval model. The first generative AI model may include a fourth AI model 430D of the AI subsystem 139.

The fourth AI model 430D may have been trained by the training engine 414. The training data engine 412 may generate training data, and each piece of training data may include an image and a corresponding text description of the image as the ground truth. The fourth AI model 430D may undergo a validation and testing process using the validation engine 416 and testing engine 420. In one implementation, the predictive component 440 may receive the first frame from the background manager 138 and provide the first frame as input to the fourth AI model 430D. The fourth AI model 430D may, as configured by its training process, generate a text description of the first frame. The fourth AI model 430D may output the text description to the predictive component 440, which may provide the text description to the background manager 138.

At block 650, processing logic may generate a generative AI prompt. The generative AI prompt may include at least a portion of the text description of the first frame generated in block 640. The background manager 138 may obtain the text description from the first generative AI model and may provide the text description to the prompt subsystem using an API.

In some implementations, the background manager 138 may input the text description into an extraction AI model. The extraction AI model may be one of the one or more AI models 430A-M of the AI subsystem 139. The extraction AI model may be configured to receive text input and extract portions of the text input. The extracted portions may include text that may be important or useful for generating AI images. The extraction AI model may have been trained on one or more portions of text with each text portion including a ground truth that includes the text to be extracted. In one example, the text description generated in block 640 may include the text “photograph of a small room with a fireplace, two red chairs, a couch; in the style of a Brooklyn apartment”. The extraction AI model may use this text description as input and produce an output text of “small room, fireplace, two red chairs, couch, Brooklyn apartment”. The background manager 138 may provide this output text to the prompt subsystem as the portion of the text description.

In some implementations, the generative AI prompt may include at least a portion of the text description of the first frame. In one or more implementations, the generative AI prompt may include at least a portion of the first frame. In one implementation, the generative AI prompt may include text input provided by the first participant. For example, as described above, the UI 106A-N may include a text box where the first participant may input text to be used to enhance the first frame. In some implementations, the generative AI prompt may include one or more image elements. For example, as described above, the UI 106A-N may include one or more selectable options that the first participant may use to select one or more image elements. The selected image elements may be included in the generative AI prompt.

At block 660, processing logic may generate an enhanced background image 554. A second generative AI model may generate the enhanced background image 554. The second generative AI model may use the generative AI prompt as input. In some implementations, the second generative AI model may include a fifth AI model 430E of the AI subsystem 139. The fifth AI model 430E may include a diffusion model. The fifth AI model 430E may have been trained by the training engine 414. The training data engine 412 may generate training data, and each piece of training data may include a text description and a corresponding ground truth that includes an image that comply with the text description. The training process may include the fifth AI model 430E repeatedly applying a diffusion denoising process to generate images that comply with the training data text description. The fifth AI model 430E may undergo a validation and testing process using the validation engine 416 and testing engine 420.

Block 660 may include the predictive component 440 obtaining the text description from the generative prompt obtained from the background manager 138 and providing the text description to the fifth AI model 430E. The fifth AI model 430E may iteratively perform a diffusion denoising process on an output image and subsequent output images based on the text description of the generative AI prompt to generate the enhanced background image 554. The fifth AI model 430E may provide the enhanced background image 554 to the predictive component 440, which may provide the enhanced background image 554 to the background manager 138.

In some implementations, the generative AI prompt may include the first frame from block 630. The fifth AI model 430E may use the first frame and the at least a portion of the text description of the first frame as input. The fifth AI model 430E may perform a diffusion denoising process on the first frame based on the at least a portion of the text description of the generative AI prompt (which, in some implementations, may include text input provided by the first participant) to generate the enhanced background image 554.

For each of one or more second frames of the video stream, at block 670, processing logic may generate a composite image by superimposing an image of the first participant depicted in a respective second frame of the one or more second frames of the video stream on the enhanced background image 554. Block 670 may include functionality similar to the functionality of block 250 of the method 200. At block 680, processing logic may cause the composite image to be presented in the first region 302A of the virtual meeting UI 106A-N in place of the respective second frame. Block 680 may include functionality similar to the functionality of block 260 of the method 200.

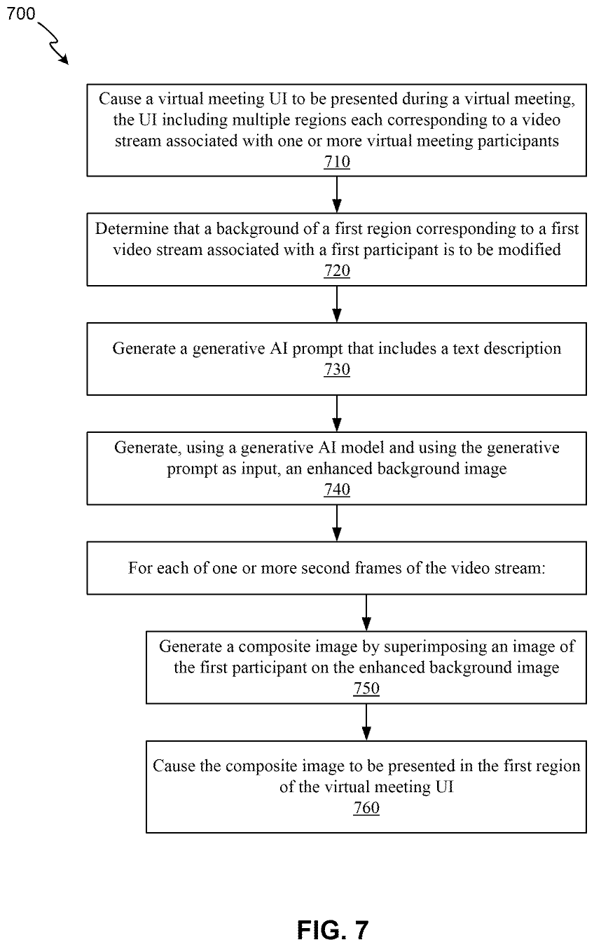

FIG. 7 is a flowchart illustrating one embodiment of a method 700 for performing background enhancement during a virtual meeting, in accordance with some implementations of the present disclosure. A processing device, having one or more (CPU(s), one or more GPU(s), and/or memory devices communicatively coupled to the one or more CPU(s) and/or GPU(s) can perform the method 700 and/or one or more of the method's 700 individual functions, routines, subroutines, or operations. In certain implementations, a single processing thread can perform the method 700. Alternatively, two or more processing threads can perform the method 700, each thread executing one or more individual functions, routines, subroutines, or operations of the method. In an illustrative example, the processing threads implementing the method 700 can be synchronized (e.g., using semaphores, critical sections, and/or other thread synchronization mechanisms). Alternatively, the processing threads implementing the method 700 can be executed asynchronously with respect to each other. Various operations of the method 700 can be performed in a different (e.g., reversed) order compared with the order shown in FIG. 7. Some operations of the method 700 can be performed concurrently with other operations. Some operations can be optional. In some implementations, the virtual meeting manager 132 or the background manager 138 may perform one or more of the operations of the method 700.

At block 710, processing logic may cause a virtual meeting UI 106A-N to be presented during a virtual meeting 122 between one or more participants. The virtual meeting UI 106A-N may include one or more regions 302 each corresponding to a video stream associated with one or more of the participants. Block 710 may include functionality similar to that of block 210 of the method 200 or block 610 of the method 600.

At block 720, processing logic may determine, during the virtual meeting 122, that the background of a first region 302A corresponding to a first video stream is to be modified in the virtual meeting UI 106A-N. The first video stream may be associated with a first participant of the one or more participants (e.g., here, the participant using the client device 102A). Block 720 may include functionality similar to that of block 220 of the method 200 or block 620 of the method 600.

At block 730, processing logic may generate a generative AI prompt that includes a text description. In some implementations, the first participant may provide at least a portion of the text description. For example, responsive to the first participant interacting with the background enhancement UI element 312, the UI 106A-N may display one or more selectable options that the participant can select to include one or more image elements in the generative AI prompt (e.g., options for large art, potted plants, enhanced lighting, windows, furniture, or other objects for the generative AI model to include in the enhanced background image 554). In some implementations, the UI 106A-N may display a text box where the first participant can input text to form an image element. After the first participant has provided user input to select one or more selectable options or has input text into a text box, the participant may interact with a “Submit” button or some other UI element to indicate that the participant has finished making their selection of image elements. In response, the UI 106A-N may send the selected/inputted image elements to the prompt subsystem to be included in the generative AI prompt.

In one or more implementations, the generative AI prompt may include an image to be included in the enhanced background image 554. The image may include an image selected by the first participant using the UI 106A-N. The image may include an image retrieved from the data store 140. The image may include an image of corporate branding.

In some implementations, the generative AI prompt may include text indicating a field of view and a focal length. The generative AI prompt may include text indicating a height of a point of view of the enhanced background image 554. The generative AI prompt may include text indicating a point of view of the enhanced background image 554 from a desk. In one implementation, a generative AI model may use one or more of these portions of text to generate the enhanced background image 554, as discussed below. In some implementations, the background manager 138 may automatically include one or more of these texts in the generative AI prompt. In some implementations, the first participant may input one or more of these texts in the UI 106A-N to be included in the generative AI prompt.

At block 740, processing logic may generate an enhanced background image 554. A generative AI model may generate the enhanced background image 554. The generative AI model may use the generative AI prompt as input. The generative AI model may include a diffusion model. The functionality of block 740 may be similar to that of block 660 of the method 600. The generative AI model may include the fifth AI model 430E, discussed above.

For each of one or more second frames of the video stream, at block 750, processing logic may generate a composite image by superimposing an image of the first participant depicted in a respective second frame of the one or more second frames of the video stream on the enhanced background image 554. Block 750 may include functionality similar to the functionality of block 250 of the method 200 or block 670 of the method 600. At block 760, processing logic may cause the composite image to be presented in the first region 302A of the virtual meeting UI 106A-N in place of the respective second frame. Block 750 may include functionality similar to that of block 260 of the method 200 or block 680 of the method 600.

In some implementations, one or more of the blocks of the methods 200, 600, or 700 may be performed on a client device 102A-N. For example, the application 105A-N may perform one or more of the blocks of the methods 200, 600, or 700.

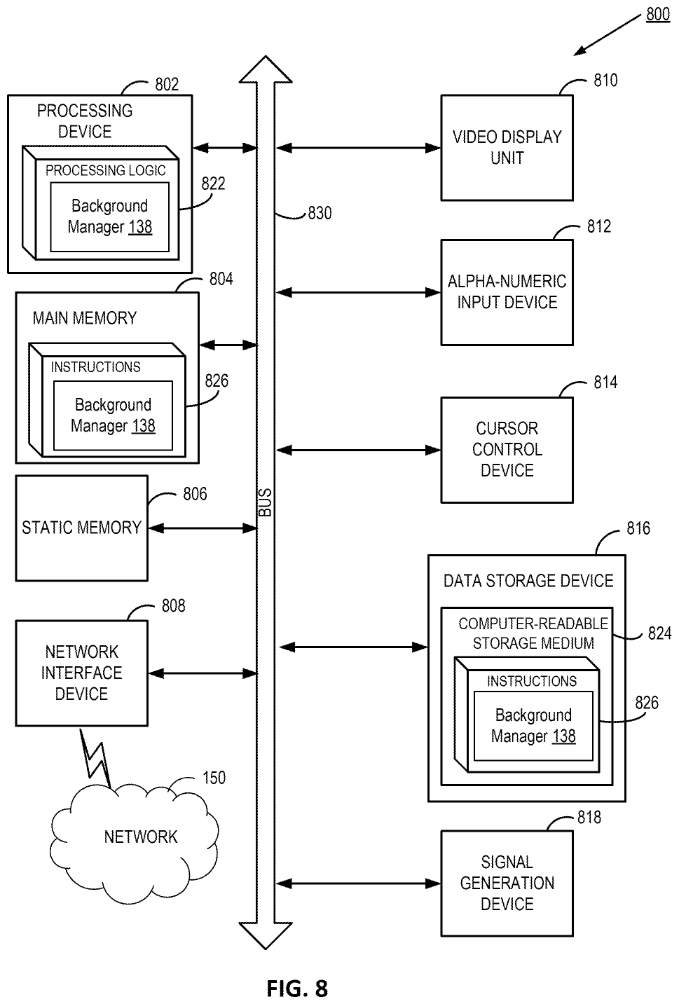

FIG. 8 is a block diagram illustrating an exemplary computer system, in accordance with implementations of the present disclosure. The computer system 800 can include a client device 102A-N, 104, the virtual meeting platform 120, or the server 130 in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a main memory 804 (e.g., read-only memory (ROM), flash memory, dynamic random access memory (DRAM) such as synchronous DRAM (SDRAM), double data rate (DDR SDRAM), or DRAM (RDRAM), etc.), a static memory 806 (e.g., flash memory, static random access memory (SRAM), etc.), and a data storage device 816, which communicate with each other via a bus 830.

The processing device 802 represents one or more general-purpose processing devices such as a microprocessor, central processing unit, or the like. More particularly, the processing device 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 can also be one or more special-purpose processing devices such as an application specific integrated circuit (ASIC), a field programmable gate array (FPGA), a digital signal processor (DSP), network processor, or the like. The processing device 802 is configured to execute the processing logic 822 for performing the operations discussed herein (e.g., the operations of the background manager 138).

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a non-transitory machine-readable storage medium 824 (sometimes referred to as a “computer-readable storage medium”) on which is stored one or more sets of instructions 826 (e.g., the instructions to carry out one or more operations of the background manager 138) embodying any one or more of the methodologies or functions described herein. The instructions can also reside, completely or at least partially, within the main memory 804 and/or within the processing device 802 during execution thereof by the computer system 800, the main memory 804 and the processing device 802 also constituting machine-readable storage media. The instructions can further be transmitted or received over the network 150 via the network interface device 808.

In one implementation, the instructions 826 include instructions for determining visual items for presentation in a user interface of a virtual meeting. While the computer-readable storage medium 824 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method, comprising:
causing a virtual meeting user interface (UI) to be presented during a virtual meeting between a plurality of participants, the virtual meeting UI comprising a plurality of regions each corresponding to a video stream associated with one or more of the plurality of participants;
determining, during the virtual meeting, that a background of a first region corresponding to a first video stream associated with a first participant of the plurality of participants is to be modified in the virtual meeting UI;
identifying a first frame of the first video stream as a candidate for the background of the first region;
generating, using a first generative artificial intelligence (AI) model and using the first frame as input to the first generative AI model, an enhanced background image; and
for each of one or more second frames of the first video stream:
generating a composite image by superimposing an image of the first participant depicted in a respective second frame of the one or more second frames of the video stream on the enhanced background image, and
causing the composite image to be presented in the first region of the virtual meeting UI in place of the respective second frame.

2. The method of claim 1, wherein:
the first frame comprises an image of the first participant located in an area of the first frame;
the method further comprises modifying the first frame by:
removing the image of the first participant from the area; and
using a second generative AI model to fill the area.

3. The method of claim 2, wherein the second generative AI model comprises a diffusion model.

4. The method of claim 1, wherein:
generating the enhanced background image further comprises using a generative AI prompt as further input to the first generative AI model; and
the generative AI prompt comprises a command for the first generative AI model to generate the enhanced background image with one or more image elements.

5. The method of claim 4, further comprising obtaining the one or more image elements from the virtual meeting UI.

6. The method of claim 1, wherein:
identifying the first frame of the video stream occurs at a virtual meeting preparation phase of the virtual meeting; and
generating the composite image occurs during a live phase of the virtual meeting.

7. The method of claim 1, wherein superimposing the image of the first participant on the enhanced background image is based on a location and a size of the image of the first participant with respect to the respective enhanced background image.

8. A method, comprising:
causing a virtual meeting user interface (UI) to be presented during a virtual meeting between a plurality of participants, the virtual meeting UI comprising a plurality of regions each corresponding to a video stream associated with one or more of the plurality of participants;
determining, during the virtual meeting, that a background of a first region corresponding to a first video stream associated with a first participant of the plurality of participants is to be modified in the virtual meeting UI;
identifying a first frame of the first video stream as a candidate for the background of the first region;
generating, using a first generative artificial intelligence (AI) model and using the first frame as input to the first generative AI model, a text description of the first frame;
generating a generative AI prompt that includes at least a portion of the text description of the first frame;
generating, using a second generative AI model and using the generative AI prompt as input to the second generative AI model, an enhanced background image; and
for each of one or more second frames of the video stream:
generating a composite image by superimposing an image of the first participant depicted in a respective second frame of the one or more second frames of the video stream on the enhanced background image, and
causing the composite image to be presented in the first region of the virtual meeting UI in place of the respective second frame.

9. The method of claim 8, further comprising removing an image of the first participant from the first frame.

10. The method of claim 8, wherein the second generative AI model comprises a diffusion model.

11. The method of claim 8, wherein the at least a portion of the text description of the generative AI prompt comprises text input provided by the first participant.

12. The method of claim 8, wherein the generative AI prompt further comprises the first frame.

13. The method of claim 8, wherein:
the generative AI prompt further comprises one or more image elements; and
the method further comprises obtaining the one or more image elements from the virtual meeting UI.

14. The method of claim 8, wherein:
identifying the first frame of the video stream occurs at a virtual meeting preparation phase of the virtual meeting; and
generating the composite image occurs during a live phase of the virtual meeting.

15. A method, comprising:
causing a virtual meeting user interface (UI) to be presented during a virtual meeting between a plurality of participants, the virtual meeting UI comprising a plurality of regions each corresponding to a video stream associated with one or more of the plurality of participants;
determining, during the virtual meeting, that a background of a first region corresponding to a first video stream associated with a first participant of the plurality of participants is to be modified in the virtual meeting UI;
generating a generative AI prompt that includes a text description;
generating, using a generative AI model and using the generative AI prompt as input to the generative AI model, an enhanced background image; and
for each of one or more second frames of the video stream:
generating a composite image by superimposing an image of the first participant depicted in a respective second frame of the one or more second frames of the video stream on the enhanced background image, and
causing the composite image to be presented in the first region of the virtual meeting UI in place of the respective second frame.

16. The method of claim 15, wherein the generative AI prompt further comprises an image to be included in the enhanced background image.

17. The method of claim 15, wherein the generative AI prompt further comprises text indicating a field of view and a focal length.

18. The method of claim 15, wherein the generative AI prompt further comprises text indicating a height of a point of view of the enhanced background image.

19. The method of claim 15, wherein the generative AI prompt further comprises text indicating a point of view of the enhanced background image from a desk.

20. The method of claim 15, wherein the generative AI model comprises a diffusion model.
